(19) United States
(12) Patent Application Publication
(10) Pub. No.: US 2025/0278345 A1
(43) Pub. Date: Sep. 4, 2025

(54) Obtaining Performance Results from Functional Testing in the Presence of Noise

(71) Applicant: ServiceNow, Inc., Santa Clara, CA (US)

(72) Inventors: Henadzi Kastyshyn, Santa Clara, CA (US); Can Bikçora, Amsterdam (NL); Himesh Bhatia, New York, NY (US); Edwin Coronado, Santa Clara, CA (US); Shayan Shahand, Amsterdam (NL)

(21) Appl. No.: 18/595,102

(22) Filed: Mar. 4, 2024

(51) Int. Cl. G06F 11/34; G06F 11/36

(52) U.S. Cl. CPC G06F 11/3409; G06F 11/3688

(57) ABSTRACT

An example implementation may involve: obtaining a first subset of test results, wherein the first subset of test results is based on a set of test cases as associated with a first version of a computing system; obtaining a second subset of test results, wherein the second subset of test results is based on the set of test cases as associated with a second version of the computing system; determining a metric based on the first subset of test results and the second subset of test results; determining, based on a noise profile of the computing system, a precision associated with the metric; and providing, based on the precision, an indication of whether the computing system exhibited a performance degradation between the first version and the second version thereof.

### BACKGROUND

Computing systems typically undergo various forms of testing before being formally released for production use. For example, functional testing may determine whether a computing system is operating as expected and in accordance with requirements. In another example, performance testing may determine the speed, responsiveness, scalability, stability, and/or resource usage of the computing system. Performance testing is undertaken separately from functional testing and involves usage of additional computing resources (e.g., processing, memory, and/or network capacity) to generate load, handle communication, and obtain results. However, interpretation of performance test results can be difficult when the computing system being tested is subject to variability or disturbances (e.g., noise) that affect performance metrics.

### SUMMARY

Various implementations disclosed herein provide mechanisms for combining functionality and performance testing, thus reducing the overall extent of computing resources used to obtain test results. In particular, batches of functional test results obtained before and after a change is made to a computing system (e.g., a software or hardware modification) can be compared with one another to determine whether the performance of the computing system has improved, degraded, or is about the same. Further, observations of noise in the computing system can be used to identify whether any differences in performance before and after the change are statistically significant. Significant differences can be identified and flagged for further review.

Accordingly, a first example embodiment may involve obtaining a first subset of test results, wherein the first subset of test results is based on a set of test cases as associated with a first version of a computing system; obtaining a second subset of test results, wherein the second subset of test results is based on the set of test cases as associated with a second version of the computing system; determining a metric based on the first subset of test results and the second subset of test results; determining, based on a noise profile of the computing system, a precision associated with the metric; and providing, based on the precision, an indication of whether the computing system exhibited a performance degradation between the first version and the second version thereof.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts a testing environment, in accordance with example embodiments.

FIG. 7 depicts a testing process, in accordance with example embodiments.

FIG. 8 depicts statistics that can be derived from comparing batches of performance results, in accordance with example embodiments.

FIG. 9 depicts test cases sorted in descending order of delta percentage, in accordance with example embodiments.

FIG. 10 is a flow chart of a procedure for determining a noise profile for a computing system, in accordance with example embodiments.

FIG. 11A depicts a representation of a noise profile for a computing system, in accordance with example embodiments.

FIG. 11B depicts measurement data underlying the noise profile of FIG. 11A, in accordance with example embodiments.

FIG. 12 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

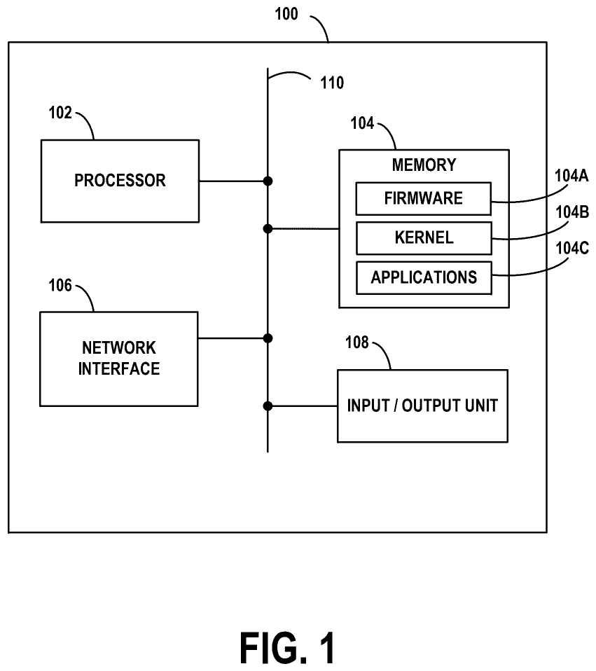

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

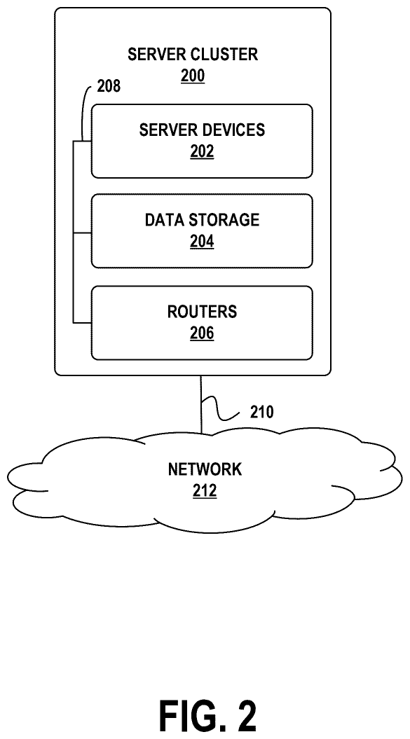

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

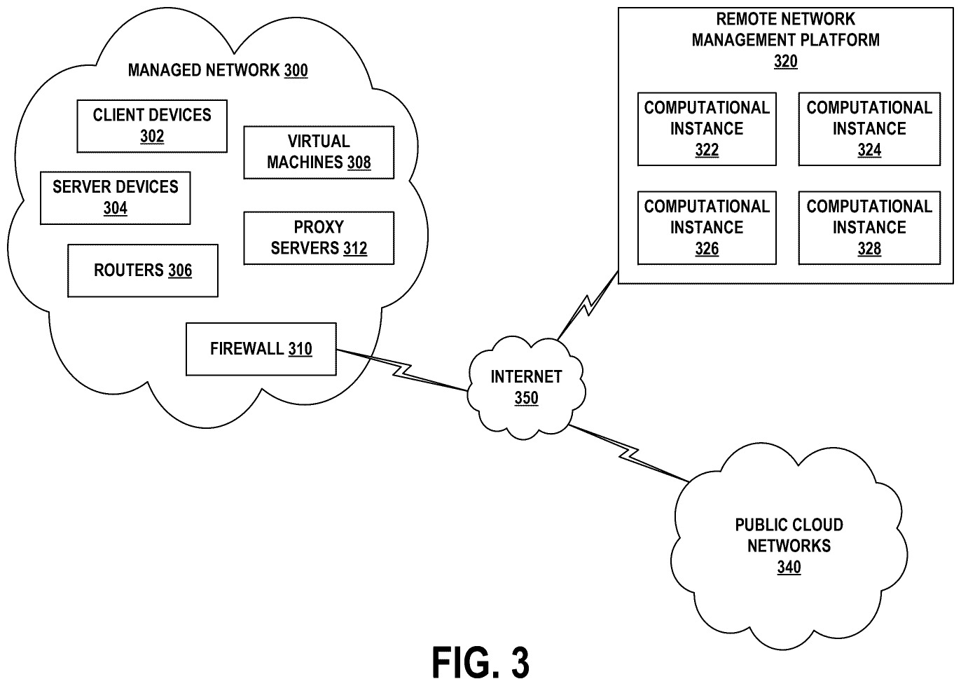

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

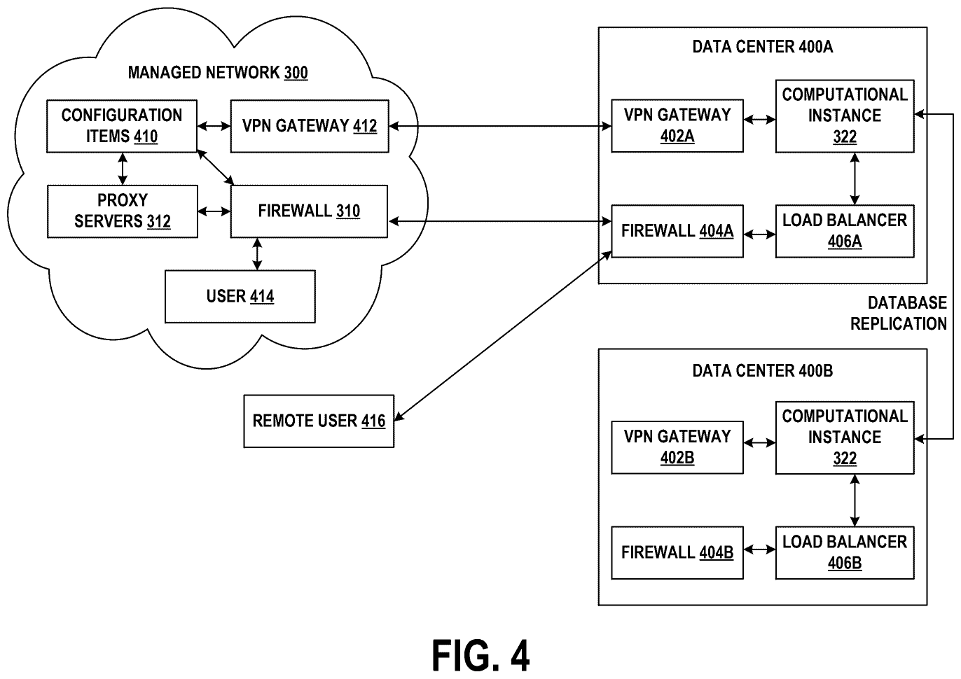

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

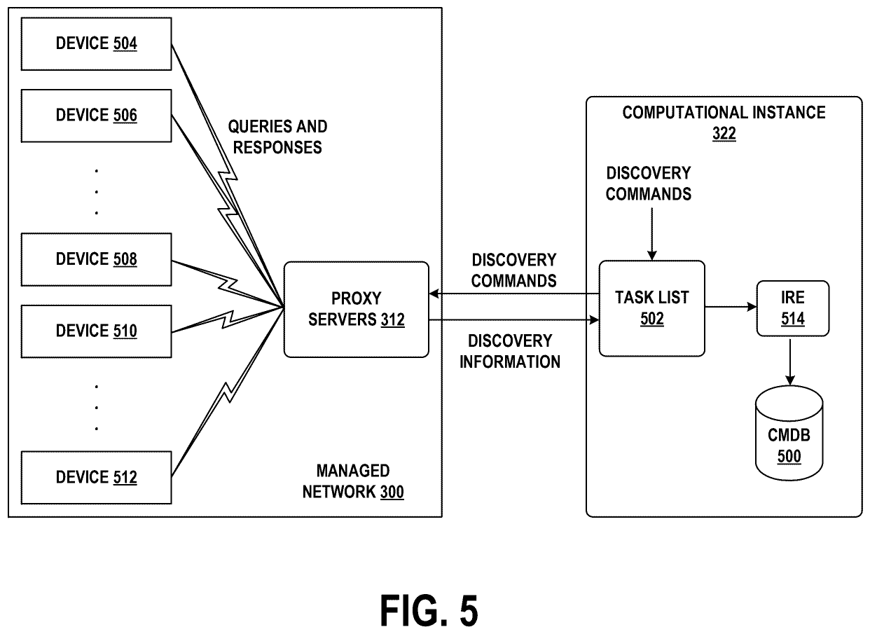

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices-for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Testing of Computing Systems

As described herein, computing systems can include one or more computing devices, as well as networking equipment and potentially non-computer peripheral devices or machinery that work together to carry out various functions and tasks. Thus, these systems may include one or more hardware devices as well as one or more software applications. For example, a computational instance (e.g., computational instance 322) may be capable of operating hundreds or thousands of software applications across several units of computing hardware, and each of these applications may be independently developed, tested, and deployed.

Whenever there is a change to the hardware or software of a computing system, the computing system may be tested to determine whether it still operates according to expectations and/or requirements, and does so in a performative manner. Such changes may be the introduction of a new software application to the system, introduction of a new feature to a software application, or modification of the hardware (e.g., upgrading to a faster processor, more processors, more memory, faster interfaces, and/or more computing devices).

A purpose of testing such a computing system is to determine whether the change impacted its reliability, functionality, performance, and/or security. For example, testing helps identify and rectify errors and defects in the computing system before it is deployed or goes live in a production environment.

While there are several categories of testing, the embodiments herein mainly focus on two: functional testing and performance testing. Various stages of testing, such as unit testing, integration testing, regression testing, and compatibility testing may encompass aspects of functional testing and/or performance testing.

Functional testing seeks to determine whether various aspects of a software application operate in conformance with its specified requirements or other expectations. This may involve validating the correctness of user interfaces, APIs, client/server transactions, databases, security, and other functionality of the software application. Functional testing may be broken down into a set of test cases, each involving a series of steps that determine whether a specific aspect of the software application operates properly. In some cases, a single software application may be subjected to hundreds or thousands of test cases. These test cases may be repeated some number of times to establish that they can produce their expected results in a repeatable manner.

Performance testing seeks to determine the speed, responsiveness, stability, scalability, and resource usage of a software application under a particular workload. It is primarily focused on how the software application (or computing system as a whole) performs under this work load, rather than whether the software application produces a correct output given a particular input (which is covered by functional testing). For purposes of simplicity, the discussion herein is directed to responsiveness (e.g., the latency in time between two events in a computing system), but other types of performance metrics can be measured. Thus, this focus should not be interpreted to limit the scope of the embodiments herein.

The discussion below contemplates scenarios in which a batch of one or more functional tests are carried out against a computing system, a change is made to the computing system, and then another batch of one or more functional tests are again carried out against the computing system. These two batches may be the same sets of tests.

By comparing the results of these tests, one may be able to determine whether the change impacted the correctness of the computing system. For instance, a feature of a software application may have been functionally correct and then became functionally incorrect due to the change. Alternatively, the feature may have been functionally incorrect and then became functionally correct due to the change. In another alternative, there was no difference in functionality in the feature before and after the change.

In some examples, only those tests that were successful (in terms of being able to be performed or in terms of obtaining the correct functional rest) both before and after the changes are used. Tests that had at least one failure result may be excluded from the performance measurement described below.

It is assumed that in these scenarios, a latency of the computing system can be measured. This latest may be, for example, the amount of time between when a request is sent as part of a test case and a corresponding response is received, also as part of the test case. The latency can be measured in terms of minutes, seconds, milliseconds, microseconds, and so on. The latency may be calculated as a difference between a timestamp recorded when the request was sent and a timestamp recorded when the response was received. Or, more generally, the latency could be the difference between when the test case begins and when it ends.

As an example, suppose that a request is sent at 15:30:25.123 (3:30 PM and 25.123 seconds) and the corresponding response is received at 15:30:25.678 (3:30 PM and 25.678 seconds) on the same day. Here, the latency is 555 milliseconds and can be calculated by converting the timestamps into integers representing milliseconds and subtracting the first from the second.

Generally speaking, low latencies are more desirable than higher latencies. Users tend to become frustrated with the slowness of computing systems when latencies are too high. Further, some software applications may operate under the implicit or explicit assumption of a particular range of latencies, and thus be unable to handle responses with latencies that fall outside of this range. Nonetheless, some baseline minimum latency is required for all transactions with a computing system due to its processor(s) needing to execute a certain number of instructions, read/write delays to and from memory, waiting for requests to other devices or systems to complete, and/or speed-of-light delays related to network transmissions.

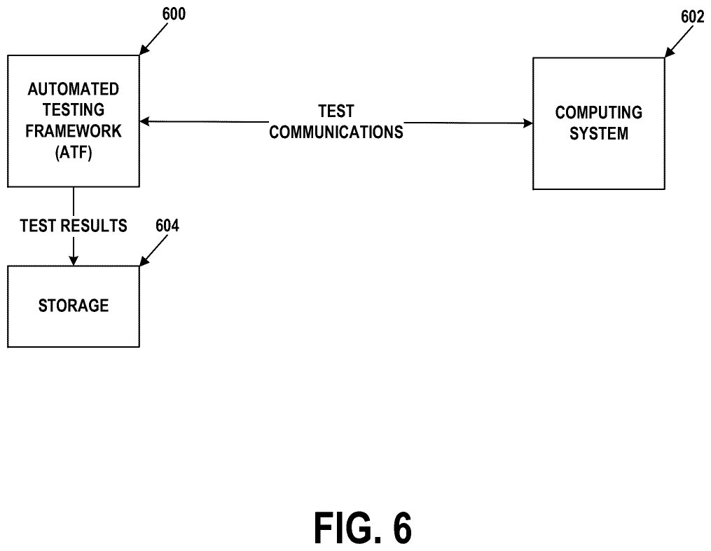

FIG. 6 depicts an example testing environment. Automated testing framework (ATF) 600 may include a suite of software tools and/or libraries operable on a one or more computing devices (i.e., testing devices) that systematically run batches of predefined test cases against computing system 602. ATF 600 and computing system 602 may be communicatively coupled by way of one or more network segments over which test communications are exchanged. ATF 600 may provide test results to storage 604 (e.g., a database or a file in a non-volatile storage medium disposed local to or remote from ATF 600). These test results may provide indications of the outcomes of each test case in terms of functionality as well as performance metrics (e.g., timestamps) that can be used to determine the latency observed during each test case.

TABLE 1

| | Correctness | |
|---|---|---|
| Test Case | (functionality) | Latency (performance) |
| 1 | [1, 1, 1, 1, 1, 1, 1, 1, 1, 1] | [447, 735, 821, 889, 776, 962, |
| | | 424, 464, 858, 838] |
| 2 | [1, 1, 1, 1, 1, 0, 1, 1, 1, 1] | [1091, 637, 392, 740, 375, 413, |
| | | 957, 696, 782, 837] |
| 3 | [1, 1, 1, 1, 1, 1, 1, 1, 1, 1] | [973, 1009, 1115, 723, 923, 946, |
| | | 1047, 1009, 1020, 807] |

Example test results are shown in Table 1 for three test cases. As indicated, each test case was run 10 times for a total of 30 tests. The correctness (functionality) and latency (performance) associated with each run are respectively stored in tuples. The correctness tuple includes binary indicators of whether the computing system provided the expected result (i.e., a 1 if the test passed and a 0 if it did not). The binary indicator for a given test may be based on comparing the outcome of the test with its expected outcome. The latency tuple includes indications of the observed latency of each test in terms of milliseconds. The latency for a given test run may be based on comparing timestamps as discussed above or through other mechanisms (e.g., a timer associated with each test).

For instance, the first test run of test case 1 exhibited the expected functionality, as reflected in its correctness indicator being a 1. This run had a latency of 447 milliseconds. On the other hand, the sixth run of test case 2 did not exhibit the expected functionality, as reflected in its correctness indicator being a 0. This run had a latency of 413 milliseconds. In general, ATF 600 may be configured to perform hundreds or thousands of tests across a multitude of test cases, with the respective test results for each being written to storage 604.

As noted, in situations similar to that of FIG. 6, performance results can be collected during functional testing. This potentially eliminates the need for extensive performance testing, and at the very least allows software engineers to more readily identify the performance characteristics of computing system 602 before and after changes are made thereto.

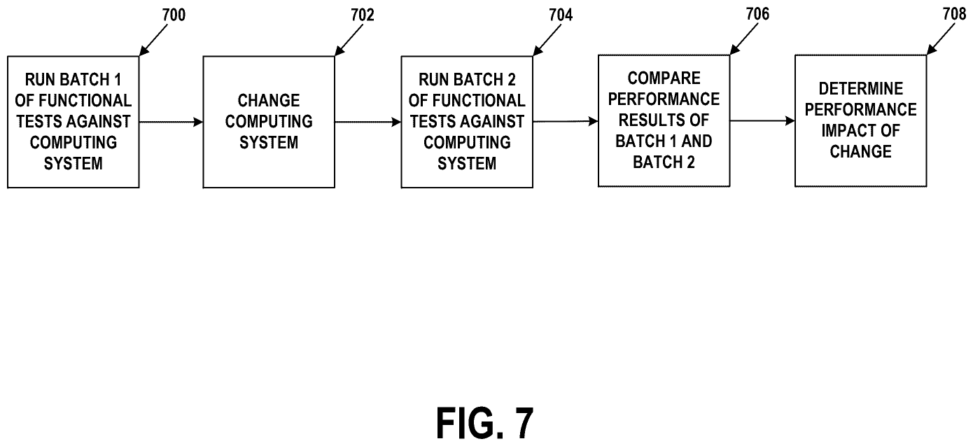

An example of this overall process is illustrated in FIG. 7. At step 700, batch 1 of functional tests may be run against a computing system. As noted, the computing system may be any combination of computing hardware and software, such as a computational instance, a web server, and cloud-based virtual server, an array of computing devices, and so on. The batch may be of various sizes (e.g., 5, 10, or 100 tests per test case) and may contain various numbers of test cases.

At step 702, a change may be made to the computing system being tested. This change may involve the addition, removal, and/or replacement of hardware (e.g., processors, memory, and/or interfaces). The change could also or alternatively involve the addition, removal, and/or replacement of software (e.g., installation of a new application, upgrading or rollback of an application to a different version, and/or a new arrangement of applications). In some cases, the change might involve a rearrangement of the computing system (e.g., placing it in a different location or modifying its network connectivity). Regardless, any such change can impact of one or both of the functionality and performance of the computing system.

Thus, at step 704, batch 2 of functional tests may be run against the computing system. Preferably, batch 2 involves running the same number of tests for the same test cases as that of batch 1. In this manner, a direct comparison can be made between the batch 1 and batch 2 test results in order to determine whether the change may have led to improved, degraded, or similar performance. Nonetheless, even if different numbers of tests are run for the same test case, the results of the two batches can still be compared, as described below.

Accordingly, at step 706, the performance results of batch 1 and match 2 are compared. This comparison may be conducted in various ways as described below. Notably, the focus herein is on the comparison of performance results across batch 1 and batch 2. Doing so is non-trivial and not amendable to use of traditional statistical techniques.

At step 708, the performance impact of the change is determined. As noted, this could be that the performance has improved, degraded, or stayed about the same.

As an example, suppose that the latency results for batch 1 are [1651, 1637, 1634, 1728, 1645, 1656, 1637, 1646, 1635, 1636] and the latency results for batch 2 are [1752, 1754, 1638, 1637, 1652, 1657, 1635, 1636, 1636, 1648] for a given test case. These latency measurements fall within a relatively narrow range (i.e., 1634-1754 milliseconds) in view of their overall magnitudes and have almost identical means (1650.5 for batch 1 and 1664.5 for batch 2). Thus, a reasonable conclusion might be that the performance of the computing system has not been significantly impacted by the changes made thereto.

However, suppose that the latency results for batch 1 are [936, 668, 650, 645, 717, 647, 649, 764, 770, 860] and the latency results for batch 2 are [1097, 648, 748, 1033, 981, 1026, 1042, 1047, 770, 768] for another test case and/or against another computing system. These latency measurements fall within a relatively large range (i.e., 645-1097 milliseconds) in view of their overall magnitudes and have rather divergent means (730.6 for batch 1 and 916 for batch 2). However, it is not clear from this data whether these test results truly indicate that the performance of the computing system has been deleteriously impacted.

Notably, all computing systems are subject to a degree of “noise” that impacts performance results. This noise may be the result of any factor that increases the variability of performance results, and includes background load, hardware caching misses, paging due to virtual memory, database-related delays, delays due to remote API calls, and delays in delivering communications between an ATF and a computing system just to name a few. Thus, systems with a high degree of noise may exhibit a relatively large amount of variability in measured latencies, while systems with a low degree of noise may exhibit a relatively small amount of such variability.

Noise can appear to be random, periodic, or some combination thereof. In many practical situations, the noise exhibited by a computing system varies in magnitude and cannot easily be predicted or modeled. Thus, it is difficult—and in some cases impossible—to determine the impact of noise from latencies measured during testing. For example, the high level of noise in the second example above (a latency range of 645-1097 milliseconds) makes it unclear whether the difference in mean latency (730.6 for batch 1 and 916 for batch 2) is significant or just a by-product of conducting tests in a noisy environment.

Furthermore, conventional use of statistical techniques and models will not provide enough insight with which to make this determination. The drawbacks associated with the mean latency measurements described above also apply to other metrics, such as median, mode, minimum, maximum, standard deviation, inter-quartile range, difference, and so on.

Ideally, it would be possible to identify which test cases exhibit a significantly different level of performance. Performance degradations are usually of most interest, such as when batch 2 of the functional tests for a given test case clearly establish that performance of the computing system is degraded in comparison to the functional tests of batch 1. Such a test case can be flagged for further testing and/or investigation (e.g., by software testers, software engineers, support engineers, etc.). However, situations in which performance improves or remains relatively static may also be of interest.

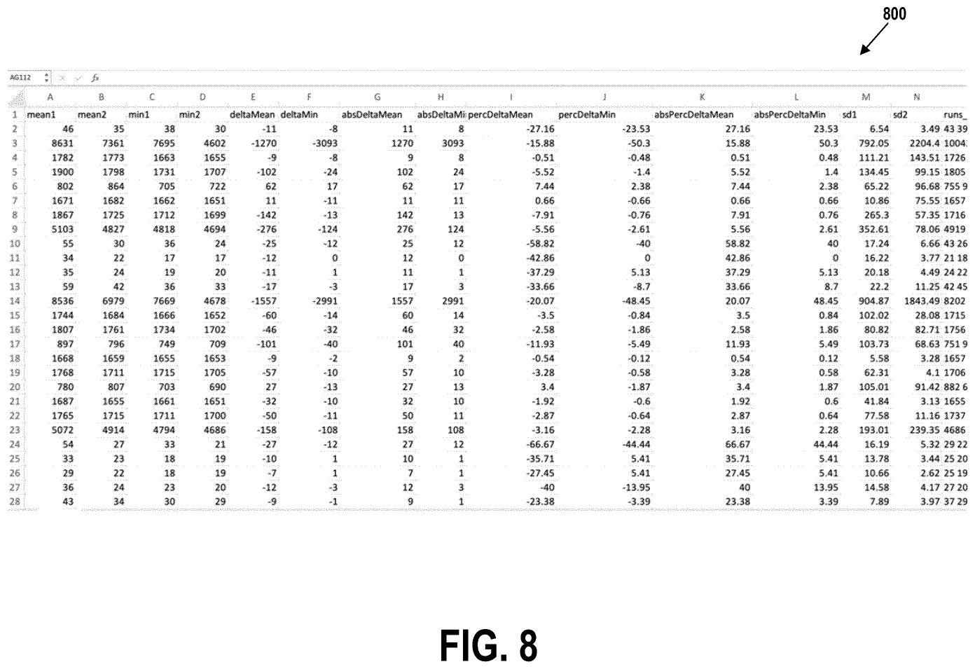

But conventional use of statistical techniques and models do not allow such an identification to happen. Instead, users are presented with a large extent of data and given few, if any, tools or suggestions of how to interpret it. As an example, FIG. 8 depicts a set of basic statistics that can be derived from comparing two batches of performance results. Each row of table 800 represents a test case. Given table 800 and little else, it is not possible to determine which of the test cases suffer from degraded performance after changes have been made to a computing system. In other words, it is prohibitively complex to map the data in table 800 to simple indications of whether each test case has passed or failed in terms of performance.

Furthermore, it may be time consuming to run more than a few tests for each individual test case. The more tests per test case that are run, the higher the level of confidence in the overall performance results. But this level of confidence may not be achievable if each test case takes several hours to run and therefore only 5, 10, or 20 runs are possible within the time available for testing the computing system.

The embodiments herein overcome these and possibly other drawbacks and limitations to performance testing in such an environment. Notably, a noise profile is determined for the computing system being tested, and this noise profile is used as the basis for determining whether a given test case is subject to a significant performance degradation between a first batch and a second batch of functional tests.

As noted, the computing system may be subject to a change (e.g., from a first version to a second version) between when the first batch and the second batch are run. The significance of differences of performance between the first batch and the second batch are based on calculation of a delta percentage. This calculation is a comparison of the test results from running the first batch and the second batch of functional tests of a particular test case. In particular, the calculation takes the form of:

$$deltaPercentage = ( mean 2 - mean 1 ) / mean 1 \times 100$$

Here, mean1 is the arithmetic mean of the individual test results for the first batch and mean2 is the arithmetic mean of the individual test results for the second batch. In some cases, a geometric or harmonic mean may be used instead. The term “mean” shall include any of these metrics as well as other measures of central tendency.

When the delta percentage is positive, it indicates that the second batch of functional tests exhibited more latency than the first batch (thus, a performance degradation may have occurred). When the delta percentage is negative, it indicates that the second batch of functional tests exhibited less latency than the first batch (thus, a performance improvement may have occurred). Test cases can be sorted in descending order of delta percentage to more easily identify those with the highest delta percentages. These test cases with the highest delta percentages are the most likely to be indicative of a significant performance degradation and therefore should be recommended for further inquiry, analysis, and/or investigation.

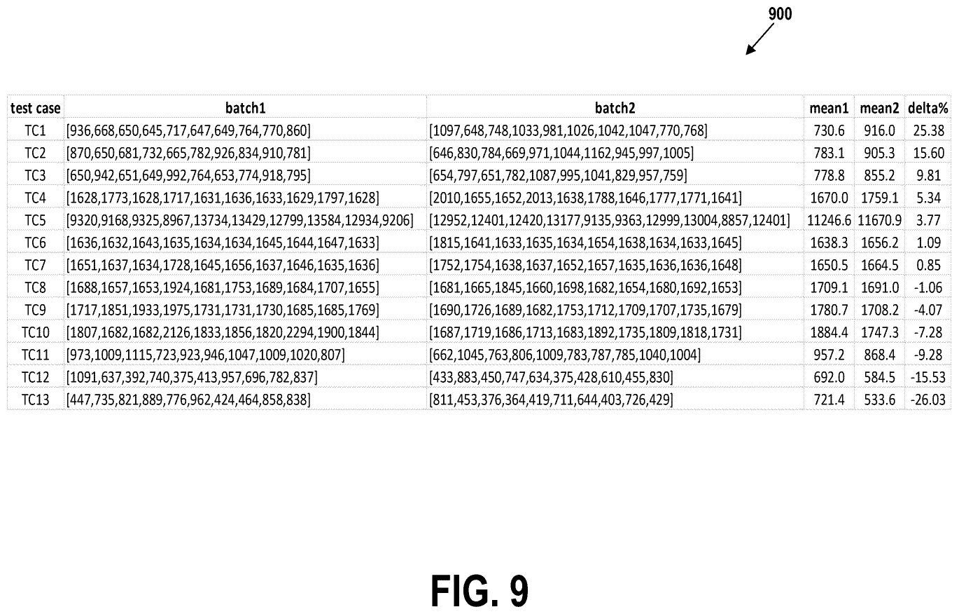

FIG. 9 provides an example list 900 of test cases sorted in descending order of delta percentage. List 900 includes, for each test case, a name (e.g., TC1), latency test results for a first batch of tests (e.g., [936, 668, 650, 645, 717, 647, 649, 764, 770, 860]), latency test results for a second batch of tests (e.g., [1097, 648, 748, 1033, 981, 1026, 1042, 1047, 770, 768]), the mean of the latency test results for the first batch of tests (e.g., 730.6), the mean of the latency test results for the second batch of tests (e.g., 916.0), and the delta percentage (e.g., 25.38).

From list 900, the test cases most indicative of a performance degradation can be easily identified as those at the top with a positive delta percentage (i.e., TC1, TC2, TC3, TC4, TC5, TC6, and TC7). However, TC1, TC2, and TC3 have a notably higher delta percentage than the others. Moreover, TC6 and TC7 both have very low (close to zero) delta percentages that suggest that any potential performance degradation observed in their results is unlikely to be significant. Therefore, given list 900, it would be beneficial to determine a delta percentage threshold above which a test case is likely exhibiting a significant performance degradation and below which a test case is unlikely to be exhibiting a significant performance degradation. In other words, the delta percentage threshold is effectively a classifier that can be used to identify test cases for which performance degradation was statistically significant.

It may not be possible to automatically select such a delta percentage threshold across a wide variety of environments with different noise characteristics. However, it is possible to allow a user to select a delta percentage threshold and then provide an indication of the accuracy of the resulting classifications (e.g., providing a level of confidence for such classifications). To do so may rely on a number of pretests performed on the computing system in order to develop a noise profile for the computing system.

Particularly, the results of these pretests can be used to determine a false alarm probability and a false okay probability for any given delta percentage threshold. The false alarm probability indicates the likelihood that a set of test results will have a delta percentage higher than the threshold—and therefore indicate a significant performance degradation—in situations where the set of tests did not actually experience a statistically significant performance degradation. Conversely, the false okay probability indicates the likelihood that a set of test results will have a delta percentage lower than the threshold—and therefore indicate no statistically significant performance degradation—in situations where the set of tests actually did experience a significant performance degradation.

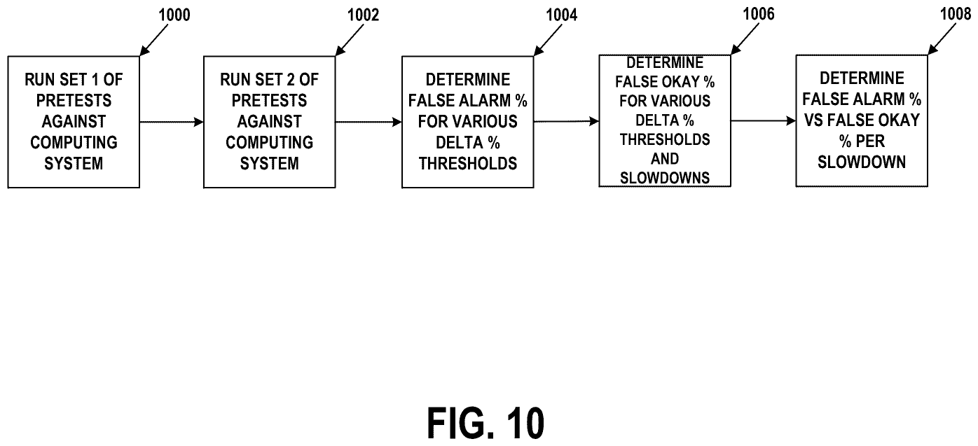

FIG. 10 depicts an example pretest procedure that results in a noise profile for a computing system. Step 1000 may involve running set 1 of pretests against a computing system, and step 1002 may involve running set 2 of pretests against a computing system.

This procedure may involve, for instance, p pairs of two batches, with each batch consisting of n runs. Here, p may be anywhere in the range of 1-25, for example, and n may be anywhere in the range of 1-100, for example. But other values of p and n may be used. As a simple illustrative example, suppose that p=1 and n=10. Suppose further that the latency results are the same as those discussed above; namely, for batch 1 they are [1651, 1637, 1634, 1728, 1645, 1656, 1637, 1646, 1635, 1636] and for batch 2 they are [1752, 1754, 1638, 1637, 1652, 1657, 1635, 1636, 1636, 1648].

Step 1004 may involve determining a false alarm percentage for various delta percentage thresholds. In this scenario, the false alarm percentage for a given delta percentage threshold d can be found by counting the number of runs in batch 2 that exceed the corresponding run of batch 1 by more than d %. Alternatively, the false alarm percentage for d can be found by counting the number of runs in batch 2 that vary (higher or lower) from the corresponding run of batch 1 by more than d %. For purposes of simplicity in the discussion below, the former definition of false alarm percentage will be used with the understanding that the same principles apply to both definitions.

This false alarm percentage is indicative of the percentage of runs that are expected to be flagged as significantly different from what is expected given d. Since batch 1 and batch 2 are close to one another in the values for each run, this means that the computing system being tested is not very noisy and a delta percentage threshold of 1 is likely to have a moderate rate of false alarms. As d increases, the false alarm percentage decreases.

In contrast, suppose that the latency results for batch 1 and 2 exhibit delta percentages of [25.38, 15.60, 9.81, 5.34, 3.77, 1.09, 0.85, −1.06, −4.07, −7.28, −9.28, −15.53, −26.03]. For d=1, 6 runs of batch 2 are more than 1% higher than their corresponding runs in batch 1. Thus, the false alarm percentage is 6/13=46%. Since batch 1 and batch 2 are vary quite a bit from one another in the values for each run, this means that the computing system being tested is noisy and a delta percentage threshold of 1 is likely to have a very high rate of false alarms.

Nonetheless, as d increases, the false alarm percentage decreases. Notably, for d=10, the false alarm percentage is 15%, for d=20, the false alarm percentage is 8%, and for d=30, the false alarm percentage is 0%. Thus, in this noisy environment, a very high delta percentage threshold should be used if the goal is to reduce the false alarm percentage.

Step 1006 may involve determining a false okay percentage for various delta percentage thresholds and various synthetic slowdowns between a pair of batches. A false okay occurs when the difference between corresponding runs in batch 1 and batch 2 is not flagged are significant when it should be flagged as such. The false okay percentage for a given delta percentage d and slowdown s can be found by: (i) adding s % to each run of batch 2, and then (ii) counting the number of runs in batch 2 that do not exceed the corresponding run of batch 1 by more than d %.

Going back to the first example of a computing system that exhibits relatively little noise, a synthetic slowdown of 25% when added to the runs of batch 2 results in the following values: [2190, 2192.5, 2047.5, 2046.25, 2065, 2071.25, 2043.75, 2045, 2045, 2060]. None of these values do not exceed their corresponding runs of batch 1 when d=1. Therefore, there are no false okays for d=1.

There is however, 1 false okay when d=20, 3 false okays when d=25, and 8 false okays when d=30. Thus, for a given value of s, the number of false okays (and thus the false okay percentage) scales roughly with d. Furthermore, the false alarm percentage and false okay percentage are inversely proportional to one another in a loose sense.

At step 1008, the false alarm percentage versus the false okay percentage is determined for a number of possible slowdowns. Such a result can appear in a graph, table, spreadsheet, file, or by some other means. In some cases, an average false alarm percentage and an average false okay percentage (or some other measure of central tendency) may be calculated over a number of runs or batches.

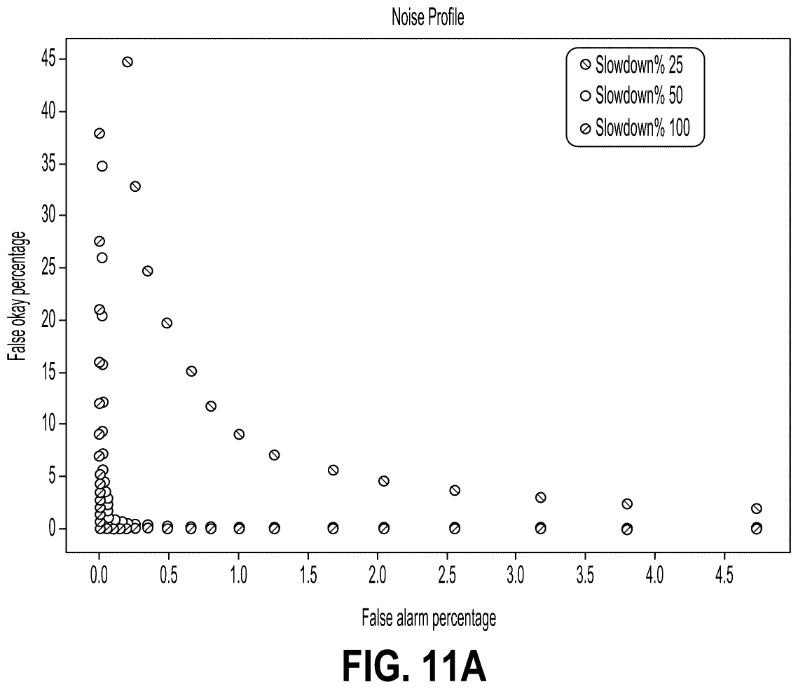

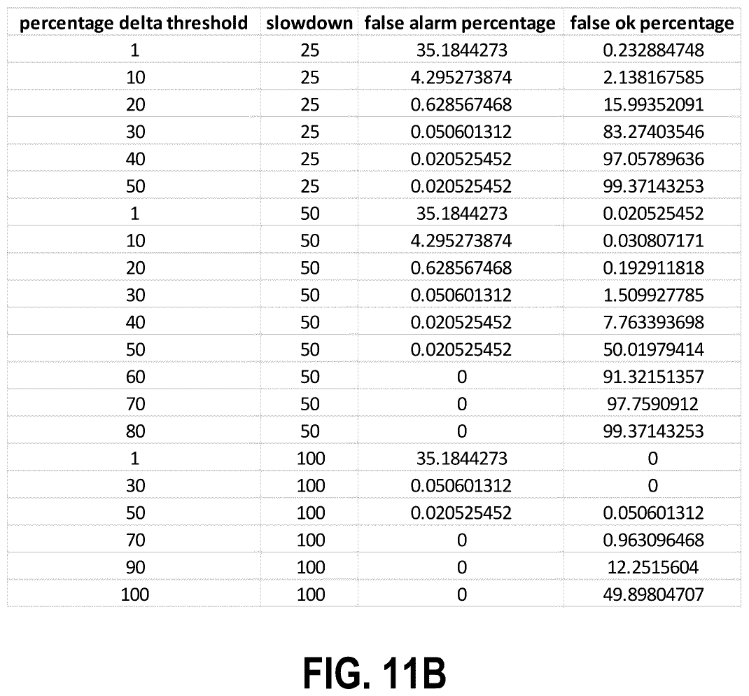

As an example, FIG. 11A depicts a graph 1100 of false alarm percentage versus false okay percentage for slowdowns (values of s) of 25%, 50%, and 100% and various values of d. An incomplete portion of the data used to plot this graph is shown in FIG. 11B (the complete data would be extensive and provide little more insight than the shown portion). Notably, this data of FIGS. 11A and 11B represents a different scenario from the ones discussed above.

For each slowdown, it is possible to identify a d that provides relatively low values of false alarm percentage and false okay percentage. Thus, such a value of d may be desirable to use as a delta percentage threshold, because tests are unlikely to be categorized as improperly representing a significant difference or improperly representing an insignificant difference. Notably, as the slowdown increases, it is easier to accurately categorize such tests because the amount of noise in the system is often much less than the slowdown.

Given this information, a value of d may be selected (preferably one results in low values of false alarm percentage and false okay percentage for a range of realistic slowdowns). Then, when actual testing occurs in accordance with the procedure of FIG. 7, step 708 is likely to accurately identify which test cases exhibit significant performance degradation, even in the presence of noise. Then, attention can be given to the identified test cases, and the features that they tested can be examined for defects that may have caused the performance degradation. For example, if a delta percentage threshold of 10% is selected for the scenario illustrated in FIG. 9, then TC1 and TC2 will be flagged as exhibiting potential performance degradation.

### VII. Example Technical Improvements

These embodiments provide a technical solution to a technical problem. One technical problem being solved relates to the computational resources needed for testing performance of a computing system. In practice, this is problematic because a significant amount of processor and memory resources may be needed on both a test framework and the computing system to carry out performance testing.

In the prior art, functional and performance testing were separate activities. Thus, performance testing required computational resources above and beyond those used for functional testing. Further, if too few performance tests were run per test case, their results would not be statically significant in situations where the test results exhibit more than a nominal amount of noise. Thus, prior art techniques did little if anything to address the computational resource utilization of performance testing as well as statistical unreliability if too few tests were performed in the presence of noise.

The embodiments herein overcome these limitations by instrumenting functional testing to provide performance test results. In this manner, performance testing can be accomplished in an efficient fashion by using functional test results. This results in several advantages. First, fewer computational resources are required since separate performance testing can be eliminated or at least reduced. Second, a noise profile of the computing system can be pre-calculated and then used to determine the statistical accuracy of test results. Third, in many cases and by employing the noise profile, less testing can take place without sacrificing accuracy in environments in which the noise profile is relatively low.

Other technical improvements may also flow from these embodiments, and other technical problems may be solved. Thus, this statement of technical improvements is not limiting and instead constitutes examples of advantages that can be realized from the embodiments.

### VIII. Example Operations

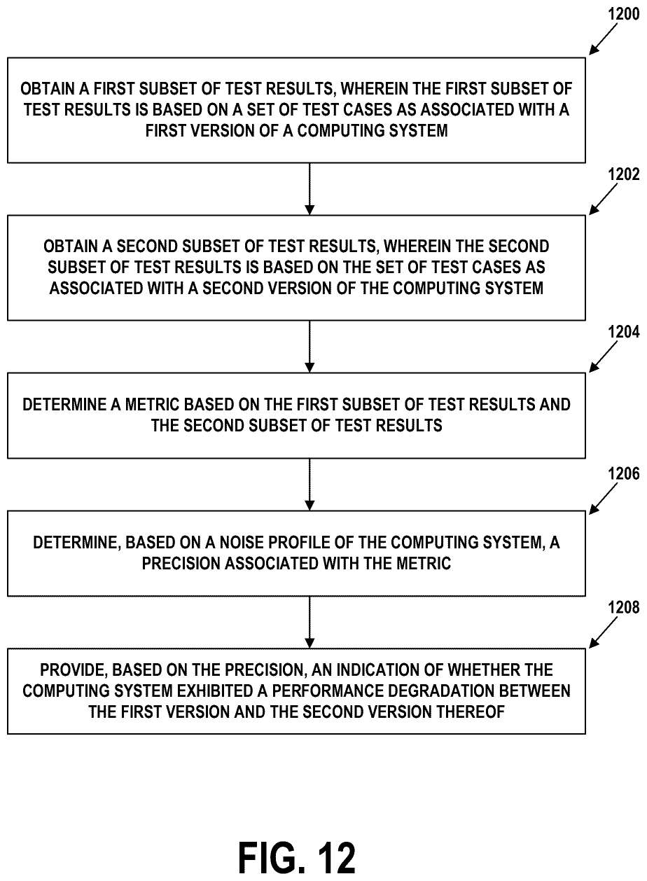

FIG. 12 is a flow chart illustrating an example embodiment. The process illustrated by FIG. 12 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 12 may be simplified by the removal of any one or more of the features shown therein. Further, these embodiments may be combined with features, aspects, and/or implementations of any of the previous figures or otherwise described herein.

Block 1200 may involve obtaining a first subset of test results, wherein the first subset of test results is based on a set of test cases as associated with a first version of a computing system.

Block 1202 may involve obtaining a second subset of test results, wherein the second subset of test results is based on the set of test cases as associated with a second version of the computing system.

Block 1204 may involve determining a metric based on the first subset of test results and the second subset of test results.

Block 1206 may involve determining, based on a noise profile of the computing system, a precision associated with the metric.

Block 1208 may involve providing, based on the precision, an indication of whether the computing system exhibited a performance degradation between the first version and the second version thereof.

In some examples, the first subset of test results are from the set of test cases being performed against the first version of the computing system, wherein the second subset of test results are from the set of test cases being performed against the second version of the computing system.

In some examples, performing the set of test cases against the first version of the computing system comprises a testing system remotely accessing the first version of the computing system, wherein performing the set of test cases against the second version of the computing system comprises the testing system remotely accessing the first version of the computing system.

In some examples, the second version is different from the first version.

In some examples, the metric is indicative of a difference between the first subset of test results and the second subset of test results.

In some examples, the difference between the first subset of test results and the second subset of test results is based on a normalized difference between mean latency values of the first subset of test results and the second subset of test results.

In some examples, the set of test cases assess functional correctness of the computing system, wherein the first subset of test results and the second subset of test results assess performance of the computing system.

In some examples, the noise profile was pre-calculated prior to obtaining the first subset of test results and the second subset of test results.

In some examples, pre-calculating the noise profile comprises: performing a first set of pretests against the computing system; performing a second set of pretests against the computing system; determining a false alarm percentage and a false okay percentage for a delta threshold, wherein the delta threshold is based on a normalized difference between mean latency values of the first set of pretests and the second set of pretests; and determining the noise profile based on the false alarm percentage and the false okay percentage for one or more slowdown percentages.

In some examples, the one or more slowdown percentages are synthetic delays applied to the second set of pretests.

In some examples, the false alarm percentage is based on a count of test runs in the second set of pretests that exceed corresponding test runs in the first set of pretests by more than the delta threshold.

In some examples, one of the slowdown percentages is applied to test runs in the second set of pretests, wherein the false okay percentage is based on a count of the test runs in the second set of pretests that do not exceed corresponding test runs in the first set of pretests by more than the delta threshold.

In some examples, determining the precision associated with the metric comprises: determining, based on the metric, an applicable false alarm percentage and an applicable false okay percentage; and determining a confidence level relating to a difference between the first subset of test results and the second subset of test results.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a first subset of test results, wherein the first subset of test results is based on a set of test cases as associated with a first version of a computing system;
obtaining a second subset of test results, wherein the second subset of test results is based on the set of test cases as associated with a second version of the computing system;
determining a metric based on the first subset of test results and the second subset of test results;
determining, based on a noise profile of the computing system, a precision associated with the metric; and
providing, based on the precision, an indication of whether the computing system exhibited a performance degradation between the first version and the second version thereof.

2. The method of claim 1, wherein the first subset of test results are from the set of test cases being performed against the first version of the computing system, and wherein the second subset of test results are from the set of test cases being performed against the second version of the computing system.

3. The method of claim 2, wherein performing the set of test cases against the first version of the computing system comprises a testing system remotely accessing the first version of the computing system, and wherein performing the set of test cases against the second version of the computing system comprises the testing system remotely accessing the first version of the computing system.

4. The method of claim 1, wherein the second version is different from the first version.

5. The method of claim 1, wherein the metric is indicative of a difference between the first subset of test results and the second subset of test results.

6. The method of claim 5, wherein the difference between the first subset of test results and the second subset of test results is based on a normalized difference between mean latency values of the first subset of test results and the second subset of test results.

7. The method of claim 1, wherein the set of test cases assess functional correctness of the computing system, and wherein the first subset of test results and the second subset of test results assess performance of the computing system.

8. The method of claim 1, wherein the noise profile was pre-calculated prior to obtaining the first subset of test results and the second subset of test results.

9. The method of claim 8, wherein pre-calculating the noise profile comprises:
performing a first set of pretests against the computing system;
performing a second set of pretests against the computing system;
determining a false alarm percentage and a false okay percentage for a delta threshold, wherein the delta threshold is based on a normalized difference between mean latency values of the first set of pretests and the second set of pretests; and
determining the noise profile based on the false alarm percentage and the false okay percentage for one or more slowdown percentages.

10. The method of claim 9, wherein the one or more slowdown percentages are synthetic delays applied to the second set of pretests.

11. The method of claim 9, wherein the false alarm percentage is based on a count of test runs in the second set of pretests that exceed corresponding test runs in the first set of pretests by more than the delta threshold.

12. The method of claim 9, wherein one of the slowdown percentages is applied to test runs in the second set of pretests, and wherein the false okay percentage is based on a count of the test runs in the second set of pretests that do not exceed corresponding test runs in the first set of pretests by more than the delta threshold.

13. The method of claim 9, wherein determining the precision associated with the metric comprises:
determining, based on the metric, an applicable false alarm percentage and an applicable false okay percentage; and
determining a confidence level relating to a difference between the first subset of test results and the second subset of test results.

14. A non-transitory computer-readable medium, having stored thereon program instructions that, upon execution by a computing device, cause the computing device to perform operations comprising:
obtaining a first subset of test results, wherein the first subset of test results is based on a set of test cases as associated with a first version of a computing system;
obtaining a second subset of test results, wherein the second subset of test results is based on the set of test cases as associated with a second version of the computing system;
determining a metric based on the first subset of test results and the second subset of test results;
determining, based on a noise profile of the computing system, a precision associated with the metric; and
providing, based on the precision, an indication of whether the computing system exhibited a performance degradation between the first version and the second version thereof.

15. The non-transitory computer-readable medium of claim 14, wherein the set of test cases assess functional correctness of the computing system, and wherein the first subset of test results and the second subset of test results assess performance of the computing system.

16. The non-transitory computer-readable medium of claim 14, wherein the noise profile was pre-calculated prior to obtaining the first subset of test results and the second subset of test results.

17. The non-transitory computer-readable medium of claim 16, wherein pre-calculating the noise profile comprises:
performing a first set of pretests against the computing system;
performing a second set of pretests against the computing system;
determining a false alarm percentage and a false okay percentage for a delta threshold, wherein the delta threshold is based on a normalized difference between mean latency values of the first set of pretests and the second set of pretests; and
determining the noise profile based on the false alarm percentage and the false okay percentage for one or more slowdown percentages.

18. The non-transitory computer-readable medium of claim 17, wherein the false alarm percentage is based on a count of test runs in the second set of pretests that exceed corresponding test runs in the first set of pretests by more than the delta threshold.

19. The non-transitory computer-readable medium of claim 17, wherein one of the slowdown percentages is applied to test runs in the second set of pretests, and wherein the false okay percentage is based on a count of the test runs in the second set of pretests that do not exceed corresponding test runs in the first set of pretests by more than the delta threshold.

20. A system comprising:
one or more processors; and
memory, containing program instructions that, upon execution by the one or more processors, cause the system to perform operations comprising:
obtaining a first subset of test results, wherein the first subset of test results is based on a set of test cases as associated with a first version of a computing system;
obtaining a second subset of test results, wherein the second subset of test results is based on the set of test cases as associated with a second version of the computing system;
determining a metric based on the first subset of test results and the second subset of test results;
determining, based on a noise profile of the computing system, a precision associated with the metric; and
providing, based on the precision, an indication of whether the computing system exhibited a performance degradation between the first version and the second version thereof.
